(19) United States
(12) Patent Application Publication
(10) Pub. No.: US 2025/0121826 A1
(43) Pub. Date: Apr. 17, 2025

(54) METHOD AND DEVICE FOR OPERATING AN AUTOMATED VEHICLE

(71) Applicant: Robert Bosch GmbH, Stuttgart (DE)

(72) Inventor: Hans-Juergen Siehr, Altensteig (DE)

(21) Appl. No.: 18/895,472

(22) Filed: Sep. 25, 2024

(30) Foreign Application Priority Data
Oct. 11, 2023 (DE) 10 2023 209 940.3

(51) Int. Cl. B60W 30/18; B60W 60/00

(52) U.S. Cl. CPC B60W 30/18159; B60W 60/0027; B60W 2554/4046

(57) ABSTRACT

A method and device for operating an automated vehicle at a traffic intersection. The method includes detecting surrounding area data values, determining a configuration of the traffic intersection, determining a movement behavior of the objects, determining a first driving strategy for the automated vehicle for passing through the traffic intersection, determining a second driving strategy for another automated vehicle, operating the automated vehicle, depending on the first driving strategy, and providing the second driving strategy for the other automated vehicle.

### CROSS REFERENCE

The present application claims the benefit under 35 U.S.C. § 119 of German Patent Application No. DE 10 2023 209 940.3 filed on Oct. 11, 2023, which is expressly incorporated herein by reference in its entirety.

### FIELD

The present invention inter alia relates to a method for operating an automated vehicle, depending on a previously determined first driving strategy.

### SUMMARY

According to an example embodiment of the present invention, a method for operating an automated vehicle at a traffic intersection comprises a step of detecting surrounding area data values, wherein the surrounding area data values represent a surrounding area of the automated vehicle, which comprises the traffic intersection, and objects in this surrounding area. The method further comprises a step of determining a configuration of the traffic intersection, a step of determining a movement behavior of the objects, and a step of determining a first driving strategy for the automated vehicle for passing through the traffic intersection, depending on the configuration of the traffic intersection and depending on the movement behavior of the objects, wherein the first driving strategy comprises a first time window for the automated vehicle for passing through the traffic intersection. The method further comprises a step of determining a second driving strategy for another automated vehicle, depending on the first time window, depending on the configuration of the traffic intersection and depending on the movement behavior of the objects, wherein the second driving strategy comprises a second time window for the other automated vehicle for passing through the traffic intersection. The method further comprises a step of operating the automated vehicle, depending on the first driving strategy, and a step of providing the second driving strategy for the other automated vehicle.

An automated vehicle is understood to mean a semi-, highly or fully automated vehicle according to one of SAE levels 1 to 5 (see standard SAE J3016).

Operating an automated vehicle, in particular depending on the driving strategy, is understood to mean, for example, executing a lateral and/or longitudinal control of the automated vehicle, wherein the lateral and/or longitudinal control takes place in such a way that the automated vehicle moves along a trajectory with a specified speed. In one possible embodiment, the operation also comprises, for example, the execution of safety-relevant functions (“arming” an airbag, fastening seat belts, etc.) and/or further (driving assistance) functions. A first and/or second driving strategy is understood here to mean, in particular, data values that represent corresponding control commands and can be received and evaluated by corresponding interfaces.

According to an example embodiment of the present invention, the surrounding area data values are detected by means of an environment sensor system designed for this purpose. An environment sensor system is understood to mean at least one video sensor and/or at least one radar sensor and/or at least one lidar sensor and/or at least one ultrasonic sensor and/or at least one further sensor that is designed to detect the surrounding area of a vehicle in the form of surrounding area data values. In one possible embodiment of the present invention, the environment sensor system comprises, for example, a computing unit (processor, working memory, hard drive) with suitable software and/or is connected to such a computing unit for this purpose. In one possible embodiment, this software comprises, for example, object recognition algorithms that are based on a neural network or artificial intelligence. A surrounding area is understood here in particular to be an area that can be detected as a whole by means of the environment sensor system.

Objects can be understood to mean static and/or dynamic objects. A static object is understood to mean, for example, an object that is not moving, at least not at the moment. These can, for example, be traffic signs (road signs, traffic lights, etc.), infrastructure features (guard rails, bridge pillars, road markings, etc.), parked vehicles, garbage cans on the side of the road, buildings, etc. A dynamic object is understood to mean, for example, an object that is currently moving. These could, for example, be other vehicles, pedestrians, cyclists, etc. The movement behavior of the objects can be understood to mean, for example, the direction of movement and/or the speed of movement.

A first and/or second time window is understood here to mean a specific period of time that is suitable for passing through the traffic intersection according to specified, in particular safety-relevant, criteria.

The method according to the present invention advantageously achieves the object of providing a method for the safe operation of automated vehicles on the one hand and for optimizing traffic flow on the other hand (in particular in the area of traffic intersections). This object may be achieved by means of the method according to the present invention in that information that is available to an automated vehicle is also made available to other (automated) vehicles, for example via C2C communication. The method takes advantage of the fact that automated vehicles in particular comprise a large number of sensors along with suitable evaluation tools in order to obtain and use information from the surrounding area of the corresponding vehicles. This allows, as described in the present method, an automated vehicle to determine a suitable time window for passing through an intersection both for itself and for other (here: following) vehicles. As a result, the other automated vehicle can pass through the traffic intersection without unnecessary braking and restarting (and also saves the corresponding energy for these processes).

Preferably, according to an example embodiment of the present invention, the first driving strategy comprises a first trajectory for the automated vehicle and/or the second driving strategy comprises a second trajectory for the other automated vehicle.

A trajectory is understood to mean, for example, in relation to a map, a line that an (automated) vehicle follows at a specified speed. In one embodiment, this line relates, for example, to a fixed point on the vehicle. In a further possible embodiment, a trajectory is understood to mean, for example, a travel route envelope through which the vehicle drives.

Preferably, according to an example embodiment of the present invention, the configuration of the traffic intersection comprises an arrangement of lanes and/or applicable traffic rules in an area of the traffic intersection.

An arrangement of lanes is understood to mean, for example, a number of lanes with a corresponding direction of travel per lane. Applicable traffic rules are understood to mean, for example, speed limits and/or rules governing, for example, the right of way at traffic intersections.

According to an example embodiment of the present invention, preferably, the second driving strategy additionally comprises the configuration of the traffic intersection.

This is understood to mean that the second driving strategy comprises additional information about the traffic intersection in the form of data values. In one possible embodiment, the second driving strategy additionally or alternatively comprises features of the first driving strategy, such as speed information, etc.

The device according to the present invention, in particular a control device, is configured to perform all steps of the method according to one of the example method embodiments for operating an automated vehicle.

For this purpose, according to an example embodiment of the present invention, the device in particular comprises a computing unit (processor, working memory, storage medium) and suitable software in order to perform the method according to one of the method embodiments. Furthermore, the device comprises an interface in order to transmit and receive data values by means of a wired and/or wireless connection, for example with further devices of the vehicle (control units, communication devices, environment sensor system, navigation system, etc.) and/or external devices (server, cloud, etc.).

Furthermore, a computer program is provided according to an example embodiment of the present invention, comprising commands that, when the computer program is executed by a computer, cause the computer to perform a method according to one of the example embodiments of the method for operating an automated vehicle according to the present invention. In one embodiment, the computer program corresponds to the software comprised by the device.

Furthermore, a machine-readable storage medium on which the computer program is stored is provided.

Advantageous developments and example embodiment of the present invention are disclosed herein.

### BRIEF DESCRIPTION OF THE DRAWINGS

Exemplary embodiments of the present invention are illustrated in the figures and explained in more detail in the following description.

FIG. 1 shows an exemplary embodiment of the method according to the present invention for operating an automated vehicle.

FIG. 2 shows an exemplary embodiment of the method according to the present invention for operating an automated vehicle in the form of a flow chart.

### DETAILED DESCRIPTION OF EXAMPLE EMBODIMENTS

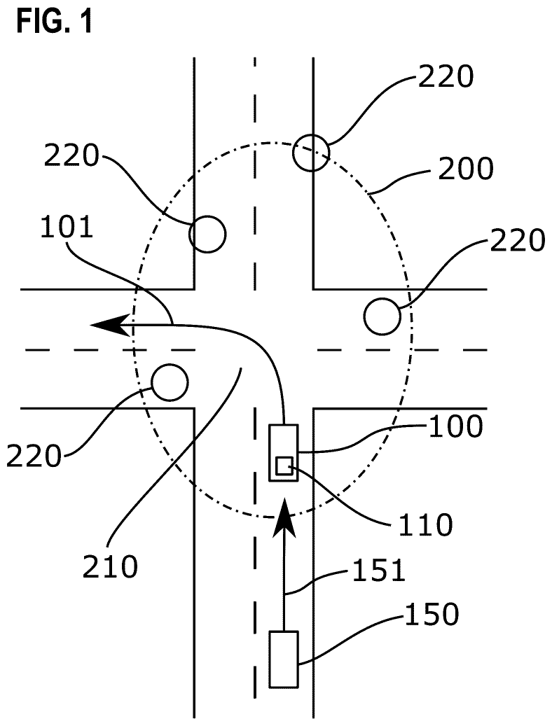

FIG. 1 shows an exemplary embodiment of the method 300 according to the present invention. An automated vehicle 100 approaches a traffic intersection 210 (shown here purely by way of example) in order to turn left (see arrow 101). Behind the automated vehicle 100, there is another automated vehicle 150, which follows the automated vehicle 100 in the direction of the traffic intersection 210 (see arrow 151).

The automated vehicle 100 comprises the device 110, which is designed to perform the method 300. Furthermore, the automated vehicle 100 comprises an environment sensor system (not shown here), which is designed to detect a surrounding area 200 of the automated vehicle 100 in the form of surrounding area data values. The surrounding area 200 comprises the traffic intersection 210 and objects 220 in the area of this traffic intersection 210.

Based on the previously detected surrounding area data values, a configuration of the traffic intersection 210 and a movement behavior of the objects 220 are now determined. This is effected by means of the device 110 or by means of further devices (computing units, control devices, etc.), which are connected to the device 110 accordingly.

Subsequently, depending on the configuration of the traffic intersection 210 and depending on the movement behavior of the objects 220, a first driving strategy for passing through the traffic intersection 210 is determined for the automated vehicle 100. The first driving strategy is determined in particular in such a way that the automated vehicle 100 uses a first time window for passing through the traffic intersection 210, which avoids a collision with the objects 220 and takes into account the configuration of the traffic intersection 210 (for example, distances, radii of curvature when cornering, etc.).

Furthermore, a second driving strategy is determined for another automated vehicle 150. This is effected depending on the first time window (since the other automated vehicle 150 must maintain a safety distance from the automated vehicle 100 in order to avoid a collision between these vehicles 100, 150), depending on the configuration of the traffic intersection 210 and depending on the movement behavior of the objects 220. The second driving strategy is determined in particular in such a way that the other automated vehicle 150 uses a second time window for passing through the traffic intersection 210, which avoids a collision with the objects 220 and takes into account the configuration of the traffic intersection 210.

This second driving strategy is then provided accordingly by the automated vehicle 100.

In addition, the automated vehicle 100 is operated depending on the first driving strategy (here: turning left for passing through the traffic intersection 210).

The other automated vehicle 150 can use the received second driving strategy directly or adapt it if necessary (because the other automated vehicle 150, for example, continues its journey, starting from the traffic intersection 210, in a different direction than the automated vehicle 100).

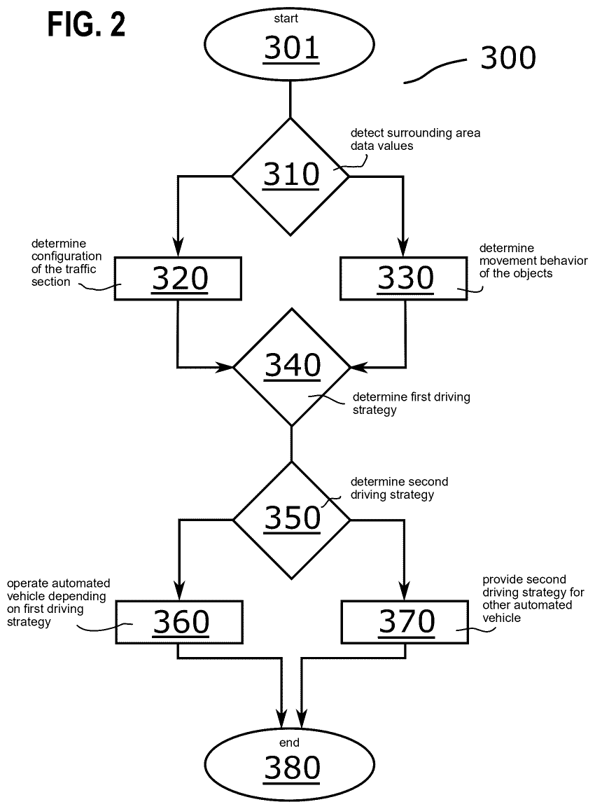

FIG. 2 shows an exemplary embodiment of a method 300 for operating 360 an automated vehicle 100 at a traffic intersection.

In step 301, the method 300 in which the automated vehicle 100 approaches a corresponding traffic intersection 210 starts. This information can be determined, for example, by means of a navigation system and a corresponding digital map and provided to the device 110 for performing the method 300.

In step 310, surrounding area data values are detected, wherein the surrounding area data values represent a surrounding area 200 of the automated vehicle 100, which comprises the traffic intersection 210, and objects 220 in this surrounding area 200.

In step 320, a configuration of the traffic intersection 210 is determined from the previously detected surrounding area data values. In a possible alternative, the configuration is additionally and/or alternatively determined by means of a map (for example, of a navigation system).

In step 330, a movement behavior of the objects 220 is determined from the previously detected surrounding area data values. This is effected, for example, by detecting the surrounding area several times, in certain time steps, and determining a temporal behavior (speeds, changes in direction, lighting up or dimming of indicators, brake and/or reversing lights, etc.) of the corresponding objects 220 therefrom.

Steps 320 and 330 can be performed in the specified order, in the reverse order, or in parallel.

In step 340, a first driving strategy for the automated vehicle 100 for passing through the traffic intersection 210 is determined depending on the configuration of the traffic intersection 210 and depending on the movement behavior of the objects 220. The first driving strategy comprises a first time window for the automated vehicle 100 for passing through the traffic intersection 210.

In step 350, a second driving strategy for another automated vehicle 150 is determined depending on the first time window, depending on the configuration of the traffic intersection 210 and depending on the movement behavior of the objects 220. The second driving strategy comprises a second time window for the other automated vehicle 150 for passing through the traffic intersection 210.

In step 360, the automated vehicle 100 is operated depending on the first driving strategy.

In step 370, the second driving strategy is provided for the other automated vehicle 150. This is understood to mean that the second driving strategy is transmitted to external receivers (here: a receiving unit of the other automated vehicle 150) by means of a transmitting unit of the automated vehicle 100 that is designed for this purpose.

Steps 360 and 370 can be performed in the specified order, in the reverse order, or in parallel.

In step 380, the method 300 ends.

What is claimed is:

1. A method for operating an automated vehicle at a traffic intersection, the method comprising the following steps:
detecting surrounding area data values, wherein the surrounding area data values represent a surrounding area of the automated vehicle, which includes the traffic intersection and objects in the surrounding area;
determining a configuration of the traffic intersection;
determining a movement behavior of the objects;
determining a first driving strategy for the automated vehicle for passing through the traffic intersection, depending on the configuration of the traffic intersection and depending on the movement behavior of the objects, wherein the first driving strategy includes a first time window for the automated vehicle for passing through the traffic intersection;
determining a second driving strategy for another automated vehicle depending on the first time window, depending on the configuration of the traffic intersection, and depending on the movement behavior of the objects, wherein the second driving strategy includes a second time window for the other automated vehicle for passing through the traffic intersection;
operating the automated vehicle, depending on the first driving strategy; and
providing the second driving strategy for the other automated vehicle.

2. The method according to claim 1, wherein the first driving strategy includes a first trajectory for the automated vehicle and/or the second driving strategy includes a second trajectory for the other automated vehicle.

3. The method according to claim 1, wherein the configuration of the traffic intersection comprises an arrangement of lanes and/or applicable traffic rules in an area of the traffic intersection.

4. The method according to claim 1, wherein the second driving strategy additionally includes the configuration of the traffic intersection.

5. A control device configured to operate an automated vehicle at a traffic intersection, the control device configured to:
detect surrounding area data values, wherein the surrounding area data values represent a surrounding area of the automated vehicle, which includes the traffic intersection and objects in the surrounding area;
determine a configuration of the traffic intersection;
determine a movement behavior of the objects;
determine a first driving strategy for the automated vehicle for passing through the traffic intersection, depending on the configuration of the traffic intersection and depending on the movement behavior of the objects, wherein the first driving strategy includes a first time window for the automated vehicle for passing through the traffic intersection;
determine a second driving strategy for another automated vehicle depending on the first time window, depending on the configuration of the traffic intersection, and depending on the movement behavior of the objects, wherein the second driving strategy includes a second time window for the other automated vehicle for passing through the traffic intersection;
operate the automated vehicle, depending on the first driving strategy; and
provide the second driving strategy for the other automated vehicle.

6. A non-transitory machine-readable storage medium on which is stored a computer program for operating an automated vehicle at a traffic intersection, the computer program, when executed by a computer, causing the computer to perform the following steps:
detecting surrounding area data values, wherein the surrounding area data values represent a surrounding area of the automated vehicle, which includes the traffic intersection and objects in the surrounding area;
determining a configuration of the traffic intersection;
determining a movement behavior of the objects;
determining a first driving strategy for the automated vehicle for passing through the traffic intersection, depending on the configuration of the traffic intersection and depending on the movement behavior of the objects, wherein the first driving strategy includes a first time window for the automated vehicle for passing through the traffic intersection;
determining a second driving strategy for another automated vehicle depending on the first time window, depending on the configuration of the traffic intersection, and depending on the movement behavior of the objects, wherein the second driving strategy includes a second time window for the other automated vehicle for passing through the traffic intersection;
operating the automated vehicle, depending on the first driving strategy; and
providing the second driving strategy for the other automated vehicle.
